(19) United States
(12) Patent Application Publication
(10) Pub. No.: US 2020/0264352 A1
(43) Pub. Date: Aug. 20, 2020

(54) Exposed-Lens Retroreflective Article Comprising Localized Color Layers

(71) Applicant: 3M INNOVATIVE PROPERTIES COMPANY, St. Paul, MN (US)

(72) Inventors: Kui Chen-Ho, Woodbury, MN (US); Anne C. Gold, South St. Paul, MN (US); Silvia G. B. Guttmann, St. Paul, MN (US); Michael A. McCoy, St. Paul, MN (US); Shri Niwas, Maple Grove, MN (US); Matthew S. Stay, Minneapolis, MN (US); Ying Xia, Woodbury, MN (US)

(21) Appl. No.: 15/733,031

(22) PCT Filed: Oct. 25, 2018
(86) PCT No.: PCT/US2018/057555

§ 371 Date: Apr. 24, 2020

Related U.S. Application Data
(60) Provisional application No. 62/675,020, filed on May 22, 2018.
(60) Provisional application No. 62/578,343, filed on Oct. 27, 2017.

(51) Int. Cl. G02B 5/136; G02B 5/28

(52) U.S. Cl. CPC G02B 5/136; B32B 2260/02; B32B 2551/00; G02B 5/286

(57) ABSTRACT

An exposed-lens retroreflective article including a binder layer and a plurality of retroreflective elements. Each retroreflective element includes a transparent microsphere partially embedded in the binder layer. At least some of the retroreflective elements comprise a reflective layer disposed between the transparent microsphere and the binder layer and at least one localized color layer that is embedded between the transparent microsphere and the reflective layer.

### BACKGROUND

Retroreflective materials have been developed for a variety of applications. Such materials are often used e.g. as high visibility trim materials in clothing to increase the visibility of the wearer. For example, such materials are often added to garments that are worn by firefighters, rescue personnel, road workers, and the like.

### SUMMARY

In broad summary, herein is disclosed an exposed-lens retroreflective article including a binder layer and a plurality of retroreflective elements. Each retroreflective element includes a transparent microsphere partially embedded in the binder layer. At least some of the retroreflective elements comprise a reflective layer disposed between the transparent microsphere and the binder layer and at least one localized color layer that is embedded between the transparent microsphere and the reflective layer. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary exposed-lens retroreflective article.

FIG. 2 is an isolated magnified perspective view of a single transparent microsphere and a localized, embedded color layer as disclosed herein.

FIG. 3 is a side schematic cross sectional view of another exemplary exposed-lens retroreflective article.

FIG. 4 is a side schematic cross sectional view of another exemplary exposed-lens retroreflective article.

FIG. 5 is a side schematic cross sectional view of an exemplary transfer article comprising an exemplary exposed-lens retroreflective article, with the transfer article shown coupled to a substrate.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

As used herein, terms such as “front”, “forward”, and the like, refer to the side from which a retroreflective article is to be viewed. Terms such as “rear”, “rearward”, and the like, refer to an opposing side, e.g. a side that is to be coupled to a garment. The term “lateral” refers to any direction that is perpendicular to the front-rear direction of the article, and includes directions along both the length and the breadth of the article. The front-rear direction (f-r), and exemplary lateral directions (l) of an exemplary article are indicated in FIG. 1.

Terms such as disposed, on, upon, atop, between, behind, adjacent, proximate, and the like, do not require that a first entity (e.g. a layer) must necessarily be in direct contact with a second entity (e.g. a second layer) that the first entity is e.g. disposed on, behind, or adjacent. Rather, such terminology is used for convenience of description and allows for the presence of an additional entity (e.g. layer) or entities therebetween, as will be clear from the discussions herein.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). For angular orientations, the term “generally” means within clockwise or counterclockwise 10 degrees. The term “substantially”, unless otherwise specifically defined, means to a high degree of approximation (e.g., within +/−10% for quantifiable properties). For angular orientations, the term “substantially” means within clockwise or counterclockwise 5 degrees. The term “essentially” means to a very high degree of approximation (e.g., within plus or minus 2% for quantifiable properties; within plus or minus 2 degrees for angular orientations); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter, particularly for the case of a parameter that is variable.

### DETAILED DESCRIPTION

FIG. 1 illustrates an exposed-lens retroreflective article 1 in exemplary embodiment. As shown in FIG. 1, article 1 comprises a binder layer 10 that comprises a plurality of retroreflective elements 20 spaced over the length and breadth of a front side of binder layer 10. Each retroreflective element comprises a transparent microsphere 21 that is partially embedded in binder layer 10 so that the microspheres 21 are partially exposed and define a front (viewing) side 2 of the article. The transparent microspheres thus each have an embedded area 25 that is seated in a receiving cavity 11 of binder layer 10, and an exposed area 24 that is exposed forwardly of binder layer 10, hence the designation of article 1 as an exposed-lens article. In at least some embodiments, the exposed areas 24 of microspheres 21 are exposed to an ambient atmosphere (e.g., air) in the final article as-used, rather than being e.g. covered with any kind of transparent protective layer. In many embodiments, the microspheres are partially embedded in the binder layer so that on average, from 15, 20 or 30 percent of the diameter of the microspheres, to about 80, 70, 60 or 50 percent of the diameter of the microspheres, is embedded within binder layer 10.

A retroreflective element 20 will comprise a reflective layer 40 disposed between the transparent microsphere 21 of the retroreflective element, and the binder layer 10. The microspheres 21 and the reflective layers 40 collectively return a substantial quantity of incident light towards the light source. That is, light that strikes the retroreflective article's front side 2 passes into and through the microspheres 21 and is reflected by the reflective layer 40 to again reenter the microspheres 21 such that the light is steered to return toward the light source.

As illustrated in exemplary embodiment in FIG. 1, at least some of the retroreflective elements 20 comprise at least one color layer 30. The term “color layer” is used herein to signify a layer that preferentially allows passage of electromagnetic radiation in at least one wavelength range while preferentially minimizing passage of electromagnetic radiation in at least one other wavelength range by absorbing at least some of the radiation of that wavelength range. By a wavelength range is meant a range within an overall spectrum that includes visible light, infrared radiation, and ultraviolet radiation. In some embodiments a color layer will selectively allow passage of visible light of one wavelength range while reducing or minimizing passage of visible light of another wavelength range. In some embodiments a color layer will selectively allow passage of visible light of at least one wavelength range while reducing or minimizing passage of light of near-infrared (700-1400 nm) wavelength range. In some embodiments a color layer will selectively allow passage of near-infrared radiation while reducing or minimizing passage of visible light of at least one wavelength range. A color layer as defined herein performs wavelength-selective absorption of electromagnetic radiation by the use of a colorant (e.g. a dye or pigment) that is disposed in the color layer, as discussed in detail later herein. Any such color layer can be arranged so that the light that is retroreflected by a retroreflective element passes through the color layer so that the retroreflected light exhibits a color imparted by the color layer.

As illustrated in exemplary embodiment in FIG. 1, at least some of the color layers 30 are localized color layers. By definition, a localized color layer 30 is a discontinuous color layer that is disposed adjacent to a portion of an embedded area 25 of a transparent microsphere 21 as shown in exemplary embodiment in FIG. 1. A localized color layer will be adjacent to, and will generally conform to, a portion (often including a rearmost portion) of the embedded area 25 of a transparent microsphere 21. By definition, a localized color layer does not comprise any portion that extends away from an embedded area 25 of a microsphere 21 along any lateral dimension of article 1 to any significant extent. In particular, such a localized color layer 30 does not extend laterally so as to bridge a lateral gap between neighboring transparent microspheres 21.

In at least some embodiments, at least some of the localized color layers 30 may be embedded color layers as shown in FIG. 1. By definition, an embedded color layer is a localized color layer that is completely surrounded (e.g. sandwiched) by the combination of the binder layer 10 and the transparent microsphere 21 (noting that a reflective layer 40 will also be present in article 1 and may contribute to the surrounding of the color layer). In other words, the minor edges 31 of the color layer (as depicted in exemplary embodiment in FIG. 1) will be “buried” between the transparent microsphere 21 and the binder material 10 rather than being exposed. That is, the locations 26 which mark the boundary between an exposed area 24 of a microsphere and an embedded area 25 of a microsphere, will be abutted by an edge 16 of binder 10 (or an edge of layer disposed thereon, as discussed later herein) rather than by the minor edge 31 of color layer 30.

It will be appreciated that in actual industrial production of retroreflective articles of the general type disclosed herein, small-scale statistical fluctuations may inevitably be present that may result in the formation of a small number of e.g. minor portions of a color layer that extend along a lateral direction and/or that exhibit a minor edge that is exposed rather than being buried, and/or in which color layers of two adjacent retroreflective elements are laterally closely abutting or even in contact with each other. Such occasional occurrences are to be expected in any real-life production process; however, an embedded color layer arrangement as disclosed herein is distinguished from circumstances in which a color layer is purposefully arranged so as to be e.g. laterally continuous and/or to comprise a significant number of exposed minor edges, or so as to comprise a significant number of color layers that are in lateral contact with each other.

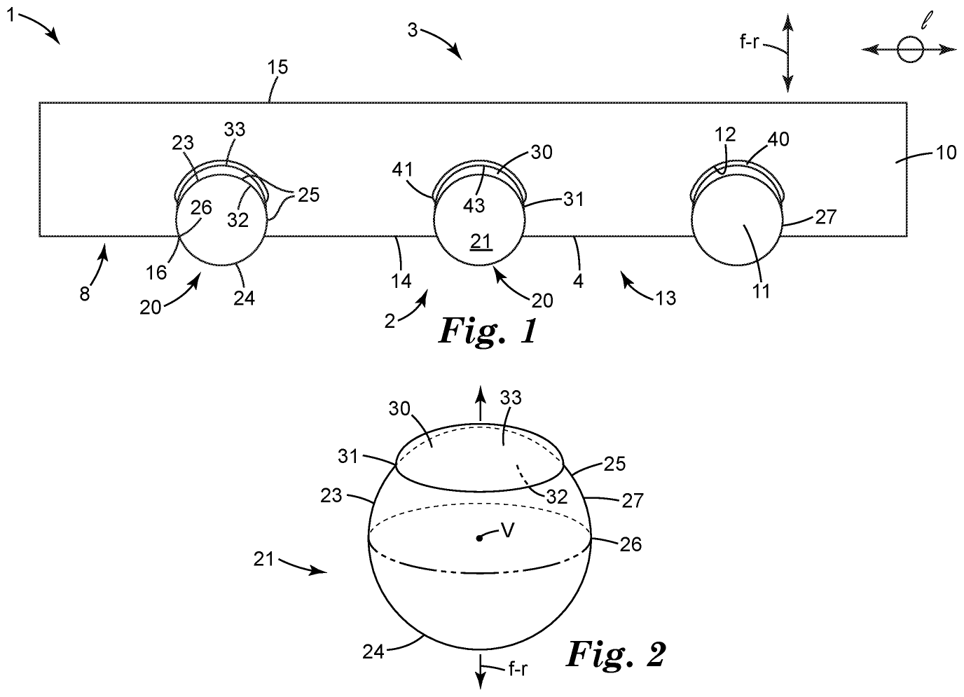

The arrangement of microspheres 21, and the methods used to dispose the color layers 30 between the transparent microspheres 21 and the binder layer 10, can be controlled to produce localized, embedded color layers 30 as discussed in detail later herein. In many embodiments, a localized, embedded color layer 30 may comprise an appearance of the general type shown in FIGS. 1 and 2. FIG. 2 is a magnified isolated perspective view of a transparent microsphere 21 and a localized, embedded color layer 30, with a binder and a reflective layer omitted for ease of visualizing color layer 30.

As shown in these Figures, a color layer 30 will often comprise a generally arcuate shape in which a major forward surface 32 of color layer 30 conforms to a portion of a major rearward surface 23 of microsphere 21. In some embodiments, major forward surface 32 of color layer 30 may be in direct contact with major rearward surface 23 of microsphere 21; however, in some embodiments major forward surface 32 of color layer 30 may be in contact with a layer (e.g. a transparent layer that serves a protective function, as a tie layer or adhesion-promoting layer, etc.) that is itself disposed on major rearward surface 23 of microsphere 21. A major rearward surface 33 of color layer 30 (e.g. a surface that is in contact with forward surface 43 of reflective layer 40, or a surface of a layer present thereon) may be, but does not necessarily have to be, congruent with (e.g. locally parallel to) the major forward surface 32 of color layer 30. This may depend e.g. on the particular manner in which the color layer is disposed on the transparent microspheres, as discussed later herein.

As evident from FIG. 2, in at least some embodiments a localized, embedded color layer 30 may be disposed so that it occupies a portion, but not the entirety, of embedded area 25 of microsphere 21. Such arrangements can be characterized in terms of the percentage of embedded area 25 that is covered by color layer 30 (regardless of whether layer 30 is in direct contact with area 25 or is separated therefrom by e.g. a tie layer or the like). In various embodiments, a color layer 30 may cover at least 5, 10, 20, 30, 40, 50, 60, or 70 percent of embedded area 25 of a microsphere 21. In further embodiments, a color layer may cover at most 95, 85, 75, 60, 55, 45, 35 or 25 percent of embedded area 25. Such calculations will be based on the actual percentage of embedded area 25 that is covered by color layer 30, rather than using e.g. plane-projected areas.

In some embodiments, a localized color layer 30 may be characterized in terms of an angular arc that the color layer occupies. For purposes of measurement, such an angular arc may be taken along a cross-sectional slice of the transparent microsphere (e.g. a slice resulting in a cross-sectional view such as in FIG. 1) and may be measured from a vertex (v) at the geometric center of transparent microsphere 21, as shown in FIG. 2. In various embodiments, a localized, embedded color layer 30 may be disposed so that it occupies an angular arc comprising less than about 200, 180, 160, 140, 120, or 100 degrees. In further embodiments, a color layer may occupy an angular arc of at least about 10, 20, 45, 65, 85, or 105 degrees. (By way of specific examples, the exemplary color layers 30 of FIG. 1 occupy an angular arc in the range of approximately 160 degrees, whereas the exemplary color layer 30 of FIG. 2 occupies an angular arc in the range of approximately 90 degrees.)

As will be made clear by the detailed discussions later herein regarding methods of making localized color layers, in many embodiments a localized color layer 30 may not necessarily be symmetrical (e.g., circular and/or centered on the front-rear axis of the transparent microsphere) when viewed along the front-rear axis of the transparent microsphere. Rather, in some cases a color layer may be non-circular, e.g. oval, irregular, lop-sided, splotchy, etc. Accordingly, if such a color layer is to be characterized by an angular arc in the manner described above, an average value of the angular arc will be reported. Such an average value can be obtained by measuring the angular arc along eight cross-sectional slices that are spaced at 45 degree increments around the microsphere (with the microsphere viewed along its front-rear axis) and taking the average of these measurements.

For a color layer that is symmetrically positioned on a microsphere e.g. as in FIGS. 1 and 2, the midpoint of any or all such angular arcs may at least substantially coincide with the front-rear axis of the microsphere. That is, for a color layer that is both symmetrically positioned and is symmetrical shaped, the geometric center of the color layer may coincide with the front-rear axis of the microsphere. However, in some embodiments a color layer may be at least slightly offset relative to the front-rear axis of the microsphere, so that at least some such midpoints may be located e.g. 10, 20 or even 30 degrees away from the front-rear axis of the microsphere.

In additional to any individual color layer exhibiting e.g. an irregular shape, the color layers may vary from each other in shape and/or size. For example, as discussed in detail later herein, color layers may conveniently be disposed on microspheres by being physically transferred to protruding portions thereof, while the microspheres are partially (and temporarily) embedded in a carrier. Since different microspheres may vary slightly in size, and/or there may be variations in the depth to which different microspheres are embedded in the carrier, different microspheres may protrude outward from the carrier to different distances. Thus for example, microspheres that protrude further outward from the carrier may receive a greater amount of color layer transferred thereto, in comparison to microspheres that are more deeply embedded in the carrier. This being the case, any of the above parameters for characterizing color layers, e.g. the angular arc occupied by the color layer or on the percentage of the embedded area of microsphere occupied by the color layer, may be an average obtained from measurements of multiple microspheres/color layers.

In various embodiments, a localized color layer may exhibit an average thickness (e.g. measured at several locations over the extent of the color layer) of from at least 0.1, 0.2, 0.5, 1, 2, 4, or 8 microns, to at most 40, 20, 10, 7, 5, 4, 3, 2 or 1 microns. Based on the discussions herein, it will be appreciated that in some embodiments the thickness of a color layer may vary somewhat over the extent of the color layer, and different color layers may exhibit different thicknesses.

The presence of localized (e.g. embedded) color layers in an exposed-lens retroreflective article may allow article 1 to comprise at least some areas that exhibit colored retroreflected light, irrespective of the color(s) that these areas (or any other areas of the article) exhibit in ambient (non-retroreflective) light. Such arrangements can be used in combination with any of the arrangements disclosed later herein by which the appearance of the article in ambient light may be manipulated.

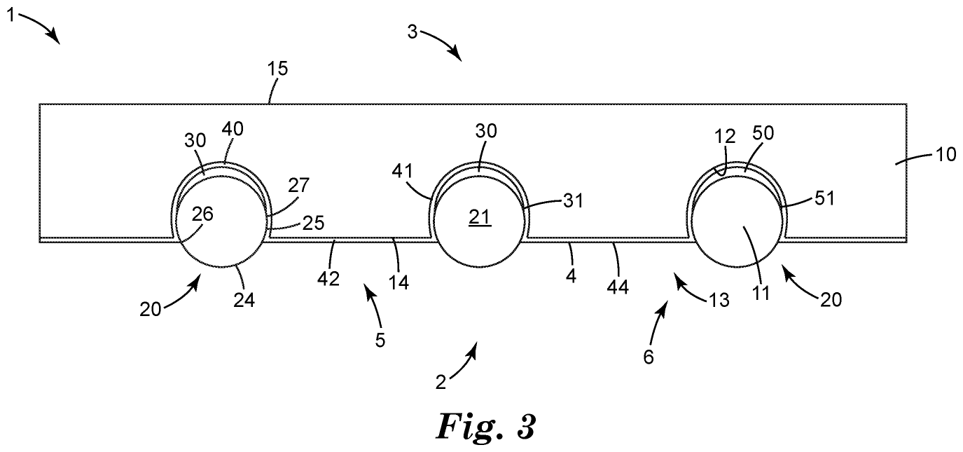

In some embodiments all of the retroreflective elements 20 that are provided with a localized color layer 30, are provided with color layers 30 of the same color. The article may thus provide retroreflected light of at least generally the same color in all retroreflective areas of the article. If desired, the retroreflective areas can be arranged so as to provide colored graphics, images, indicia, or the like, when viewed in retroreflected light. In some embodiments, one or more areas 5 of article 1 may comprise retroreflective elements that comprise localized color layers 30 of a first color, as shown in exemplary embodiment in FIG. 3. Also as shown in FIG. 3, one or more second areas 6 of article 1 may comprise retroreflective elements that comprise second localized color layers 50 of a second color that is different from the first color of first color layer 30. In at least some embodiments, second localized color layers 50 may be embedded color layers, e.g. with “buried” minor edges 51 as indicated in FIG. 3.

In general, by two colors being different from each other is meant that the colors exhibit an (x, y) chromaticity difference (i.e. a linear distance as calculated by the usual square-root method) of at least 0.01 in a CIE 1931 XYZ color space chromaticity diagram. (It will be appreciated that many colors may differ so markedly from each other that they can be established as being different from each other merely by casual inspection.) With specific regard to colors exhibited in retroreflected light, retroreflective elements will be considered to exhibit different colors if they exhibit (x, y) coordinates that differ by a linear distance of at least 0.01 units in a CIE 1931 XYZ color space chromaticity diagram, when viewed in retroreflected light at an observation angle of 0.2 degrees and at an entrance angle of either 5 degrees or 30 degrees. In some embodiments, a first color layer of a first retroreflective element may exhibit a color that differs from that of a second color layer of a second retroreflective element, as manifested by a chromaticity difference of at least 0.02, 0.05, 0.10, 0.15, 0.20, 0.30, or 0.40, when viewed in retroreflected light at an observation angle of 0.2 degrees and at an entrance angle of 5 degrees. In further embodiments, two such color layers may exhibit a chromaticity difference of at least 0.02, 0.05, 0.10, 0.15, 0.20, 0.30, or 0.40, e.g. when viewed in retroreflected light at an observation angle of 0.2 degrees and at an entrance angle of 30 degrees.

Such arrangements may allow a retroreflective article 1 to comprise some areas that exhibit retroreflected light of a first color, and other areas that exhibit retroreflected light of a second, different color. Such arrangements may be provided irrespective of the color(s) that the article exhibits in ambient (non-retroreflective) light, and can be used in combination with any of the arrangements disclosed below by which the appearance of the article in ambient light may be manipulated.

In some embodiments, at least some retroreflective elements 20 may comprise multiple (e.g. two) localized (e.g. embedded) color layers 30, in a stacked (overlapping) configuration so that retroreflected light may pass through one or both color layers depending on the entrance and/or observation angle. In particular embodiments, a first localized color layer may be larger than a second localized color layer (e.g. so that the first color layer occupies a larger angular arc according to the descriptions above). In such a case, retroreflected color at low (e.g. head-on) entrance and/or observation angles may exhibit color imparted by the combination of both color layers, while retroreflected color at high (e.g. glancing) entrance and/or observation angles may exhibit color imparted only by the first color layer. That is, at sufficiently high angles, the light may pass only through the portions of the first color layer that are not in overlapping relation with the second color layer. Such articles may thus exhibit retroreflective colors that change as desired, depending on the entrance and/or observation angle of the retroreflected light. (As discussed later herein in detail, it is also possible to choose the relative size of a color layer and a reflective layer with which it shares a retroreflective light path so that the retroreflective color changes as desired, or remains constant as desired, with varying entrance and/or observation angles.) In cases in which two (or more) color layers are present in stacked configuration, the color layers may be chosen so that light that passes through the layers exhibits a desired overall color that is imparted by the layers in combination.

Article 1 may be arranged to provide that the appearance of article 1 in ambient (non-retroreflected) light is controlled as desired. For example, in the exemplary arrangement of FIG. 1 (in which the reflective layers 40 are discontinuous) the front surface 4 of article 1 is provided in part (e.g. in areas 8 of front side 2 of article 1 that are not occupied by transparent microspheres 21) by a visually exposed front surface 14 of binder layer 10. In such embodiments the appearance of front side 2 of article 1 in ambient light may thus be largely dominated by the color (or lack thereof) of binder layer 10 in areas 13 of binder layer 10 that are laterally between microspheres 21. In some such embodiments binder layer 10 may be a colorant-loaded (e.g. pigment-loaded) binder layer. The pigment may be chosen to impart any suitable color in ambient light, e.g. fluorescent yellow, green, orange, and so on.

In other arrangements e.g. as shown in FIG. 3, the reflective layer 40 may be a continuous, opaque reflective layer that includes portions 42 that are disposed on front surface 14 of binder layer 10 (e.g. so that front surface 44 of reflective layer portions 42 provides visually exposed front surface 4 of article 1 in between-microsphere areas 8 of article 1). Such an article may thus exhibit an appearance in ambient light that is largely dominated by portions 42 of opaque reflective layer 40 (for example, a reflective layer such as e.g. a vapor-deposited metal layer may often exhibit a relatively neutral, e.g. gray, color in ambient light). However, in such circumstances, a binder layer 10 may or may not be a pigmented, as desired for whatever purpose.

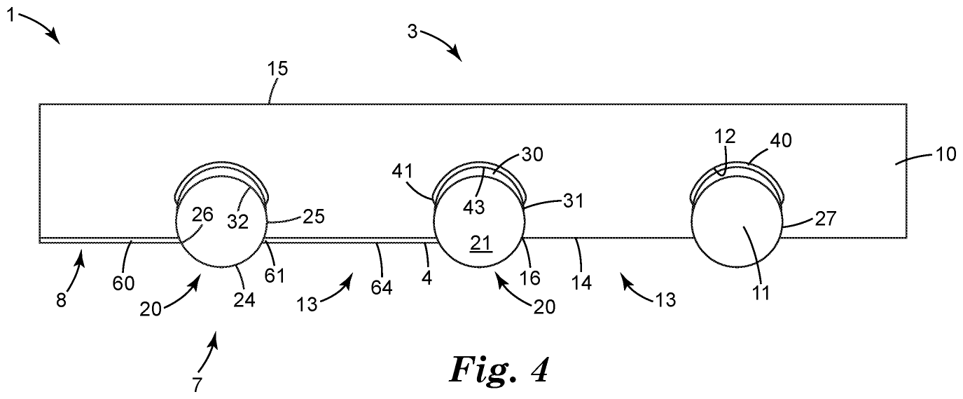

In some embodiments, at least a portion of a front surface of article 1 in areas 8 laterally between the transparent microspheres 21, can be provided by a visually exposed surface 64 of a non-localized color layer 60 as shown in exemplary embodiment in FIG. 4. Such a non-localized color layer 60 may extend continuously over a selected area 7 of article 1, although it may be interrupted by the transparent microspheres 21. In such a case, the appearance in ambient light of at least a selected area 7 of front side 2 of article 1 may be governed at least in part by a non-localized color layer 60. A non-localized color layer 60 may be provided on the entirety of the length and breadth of article 1; or, it may be provided only in a selected area of areas 7. If desired, multiple non-localized color layers may be provided in different areas, e.g. arranged so as to provide graphics, images, indicia, or the like. Such a non-localized color layer or layers may present in embodiments comprising reflective layers that are localized or non-localized, as desired (in the latter instance, the non-localized color layer may be used to obscure or camouflage the above-noted somewhat neutral or gray appearance typically exhibited by some continuous reflective layers).

It will be appreciated that e.g. if a lateral edge 61 of a non-localized color layer 60 closely abuts a lateral edge of a transparent microsphere 21, the presence of the non-localized color layer 60 may have at least some effect on the color of high-angle retroreflected light. That is, light that enters a transparent microsphere 21 at least generally along the front-rear axis of the article may exhibit a color in retroreflectivity that is largely dominated by a localized color layer 30, while light that enters at a high (e.g. glancing) angle may exhibit a color in retroreflectivity that is affected at least somewhat by the non-localized color layer 60. Such phenomena may be used to advantage if desired, and may be facilitated by using a reflective layer that extends sufficiently forwardly around the transparent microsphere to ensure that light that enters at a high angle will be retroreflected.

It is emphasized that any of the arrangements disclosed herein by which the appearance of article 1 in ambient light may be manipulated, may be used in combination with any of the arrangements disclosed herein by which the appearance of article 1 in retroreflected light may be manipulated. Such arrangements are not limited to e.g. the exemplary combinations shown in the Figures. Thus, for example, an article 1 may comprise one or more areas 5 that comprise a first localized color layer 30 and one or more areas 6 that comprise a second localized color layer 50; either or both such areas may comprise one or more areas 7 that comprise non-localized color layers 60. Any number of localized color layers and/or non-localized color layers may be used, and may be used in combination with continuous or discontinuous reflective layers 40, with an unpigmented binder layer 10 or a pigmented binder layer 10, and so on.

In some particular embodiments, a retroreflective article 1 may be configured so that at least some portions of the article exhibit a similar, or at least substantially the same, color in ambient light as they exhibit in retroreflected light. This may be achieved e.g. by appropriately selecting a colorant of e.g. a binder layer 10 and/or of a non-localized color layer 60, in view of a colorant used in a localized color layer 30. In some alternative embodiments, the various colorants may be selected and arranged so that at least portions of the article exhibit a different color in retroreflection than they do in ambient light. In various embodiments, at least portions of article 1 may exhibit an (x, y) chromaticity difference of at least 0.01, 0.02, 0.05, 0.10, 0.15, 0.20, 0.30, or 0.40 when observed in retroreflected light (e.g. at an observation angle of 0.2 degrees and an entrance angle of 5 degrees) versus when observed in ambient light. In other embodiments, at least portions of article 1 may exhibit an (x, y) chromaticity difference of less than 0.35, 0.25, 0.18, 0.13, or 0.08 when observed in retroreflected light (e.g. at an observation angle of 0.2 degrees and an entrance angle of 5 degrees) versus when observed in ambient light.

As noted earlier, in some instances at least some retroreflective elements may each exhibit a retroreflective color that changes as a function of the entrance angle and/or the observation angle. Thus in various embodiments, at least portions of article 1 may exhibit an (x,y) chromaticity difference of at least 0.01, 0.02, 0.05, 0.10, 0.15, 0.20, 0.30, or 0.40 when observed in retroreflected light at an observation angle of 0.2 degrees and an entrance angle of 5 degrees, versus when observed in retroreflected light at an observation angle of 0.2 degrees and an entrance angle of 30 degrees.

As noted briefly above, a retroreflective element 20 will comprise a reflective layer 40 disposed between the transparent microsphere 21 and the binder layer 10. In many embodiments, the reflective layer 40 will be disposed at least between the embedded area 25 of microsphere 21 and the underlying surface 12 of binder layer 10. Reflective layer 40 will be disposed behind color layer 30 (e.g. between rearward surface 33 of color layer 30 and the underlying surface 12 of binder layer 10) so that the color layer 30 is in the retroreflective light path as mentioned above. In various embodiments, a reflective layer may comprise an average thickness of at least 10, 20, 40 or 80 nanometers; in further embodiments a reflective layer may comprise an average thickness of at most 10, 5, 2 or 1 microns, or of at most 400, 200 or 100 nanometers.

In some embodiments a reflective layer 40 may be a discontinuous reflective layer, e.g. a localized reflective layer that is located only in the region described above, as shown in exemplary embodiment in FIG. 1. In particular embodiments a localized reflective layer 40 may be an embedded reflective layer (with the terms localized and embedded having the same meanings as used for color layers as discussed above). That is, an embedded reflective layer 40 may comprise minor edges 41 that are “buried” rather than being exposed edges.

In some embodiments, an embedded reflective layer may be configured so that the entirety of the portion of the reflective layer that is in the retroreflective light path, is positioned rearwardly of a localized color layer. This can ensure that incoming light cannot reach the reflective layer (nor be reflected therefrom) without passing through the color layer, regardless of the angle at which the light enters and exits the transparent microsphere. Such arrangements can provide that light that is retroreflected from a retroreflective element exhibits a desired color, regardless of the entrance/exit angle of the light. (Such arrangements can also provide that the appearance of the retroreflective element in ambient light will be governed by the color layer rather than by the reflective layer.)

The previously mentioned parameters (e.g., the angular arc occupied by a layer, and the percentage of the embedded area of the microsphere that is covered by a layer) can be used for characterization of a localized reflective layer e.g. in relation to a localized color layer with which it shares a retroreflective light path, in order to describe such arrangements.

In various embodiments, an embedded reflective layer 40 may be disposed so that it occupies an angular arc comprising less than about 190, 170, 150, 130, 115, or 95 degrees. In further embodiments, an embedded reflective layer may occupy an angular arc of at least about 15, 40, 60, 80, 90, or 100 degrees. In various embodiments, an embedded reflective layer may be disposed so that it occupies an angular arc that is less than that of an embedded color layer with which it shares a retroreflective light path, by at least 5, 10, 15, 20, 25, or 30 degrees.

In other embodiments, an embedded reflective layer may be disposed so that it occupies an angular arc that is greater than that of an embedded color layer with which it shares a retroreflective light path, by at least 5, 10, 15, 20, 25 or 30 degrees. In such arrangements, retroreflected light may exhibit a color imparted by the color layer at relatively low angles (e.g. head-on), and may exhibit a color (e.g. generally a whitish color) imparted by the reflective layer in the absence of a color layer at relatively high (e.g. glancing) angles.

In other embodiments a reflective layer 40 may be a non-localized reflective layer, e.g. a continuous reflective layer, that comprises portions that extend laterally beyond the localized region described above. For example, in some embodiments a reflective layer 40 may include portions 42 that extend laterally between microspheres 21 as discussed earlier herein. Such portions 42 may be provided over at least one or more macroscopic areas of the retroreflective article, as shown in exemplary embodiment in FIG. 3.

In some embodiments, a reflective layer may comprise a metal layer, e.g. a single layer of vapor-deposited metal (e.g. aluminum or silver). Such a deposition method may be particularly suited for providing a non-localized, e.g. continuous, reflective layer, although the deposition may be e.g. masked in order to provide the reflective layer only in certain macroscopic areas of the article as desired. Moreover, in some embodiments, portions of a previously-deposited (e.g. a vapor-deposited) reflective layer may be removed, e.g. by etching, to transform a continuous reflective layer into a discontinuous reflective layer, as discussed in further detail later herein.

In some embodiments, a reflective layer may comprise a dielectric reflective layer, comprised of an optical stack of high and low refractive index layers that combine to provide reflective properties. Such a material may be suited for use e.g. as a continuous reflective layer or as a discontinuous reflective layer. Dielectric reflective layers are described in further detail in U.S. Patent Application Publication No. 2017/0131444, which is incorporated by reference in its entirety herein for this purpose. In particular embodiments, a dielectric reflective layer may be so-called layer-by-layer (LBL) structure in which each layer of the optical stack (i.e., each high-index layer and each low-index layer) is itself comprised of a substack of multiple bilayers. Each bilayer is in turn comprised of a first sub-layer (e.g. a positively charged sub-layer) and a second sub-layer (e.g. a negatively charged sub-layer). At least one sub-layer of the bilayers of the high-index substack will comprise ingredients that impart a high refractive index, while at least one sub-layer of the bilayers of the low-index substack will comprise ingredients that impart a low refractive index. LBL structures, methods of making such structures, and retroreflective articles comprising dielectric reflective layers comprising such structures, are described in detail in U.S. Patent Application Publication No. 2017/0276844, which is incorporated by reference in its entirety herein.

In some embodiments, a reflective layer may comprise a printed or coated layer (e.g. comprising a reflective material such as metallic aluminum or silver). For example, a flowable precursor comprising a reflective material (e.g. a silver ink) may be disposed (e.g. printed) atop at least a portion of areas 25 of microspheres 21 and then solidified into a reflective layer. If desired, the reflective layer may be heat treated (e.g. sintered) to enhance the reflectivity of the layer. Such a material may be suited for use as a continuous reflective layer or as a discontinuous reflective layer.

In particular embodiments, a printed or coated reflective layer may comprise particles, e.g. flakes, of reflective material (e.g. aluminum flake powder, pearlescent pigment, etc.), e.g. as described in U.S. Pat. No. 5,344,705, which is incorporated by reference in its entirety herein. In some embodiments, binder layer 10 may be loaded with particles, e.g. flakes, of reflective material or pearlescent material, so that at least a portion of binder layer 10 that is rearwardly adjacent to transparent microsphere 21 and color layer 30 can provide a reflective layer 40 as disclosed herein. (In such a design, this portion of binder layer 10 will be considered to comprise a reflective layer that is disposed between the transparent microsphere 21 and the (rearward portion of) binder layer 10.) In some embodiments, a reflective layer (e.g. a localized embedded reflective layer) may be a “transferred” reflective layer, meaning a reflective layer that is separately made and is then physically transferred (e.g. laminated) to a carrier-borne transparent microsphere. Such “transferred” reflective layers are described in detail in U.S. Provisional Patent Application No. 62/578,343 (e.g., in Example 2.3 (including Examples 2.3.1-2.3.3) and Example 2.4 (including Examples 2.4.1-2.4.5), which is incorporated by reference in its entirety herein.

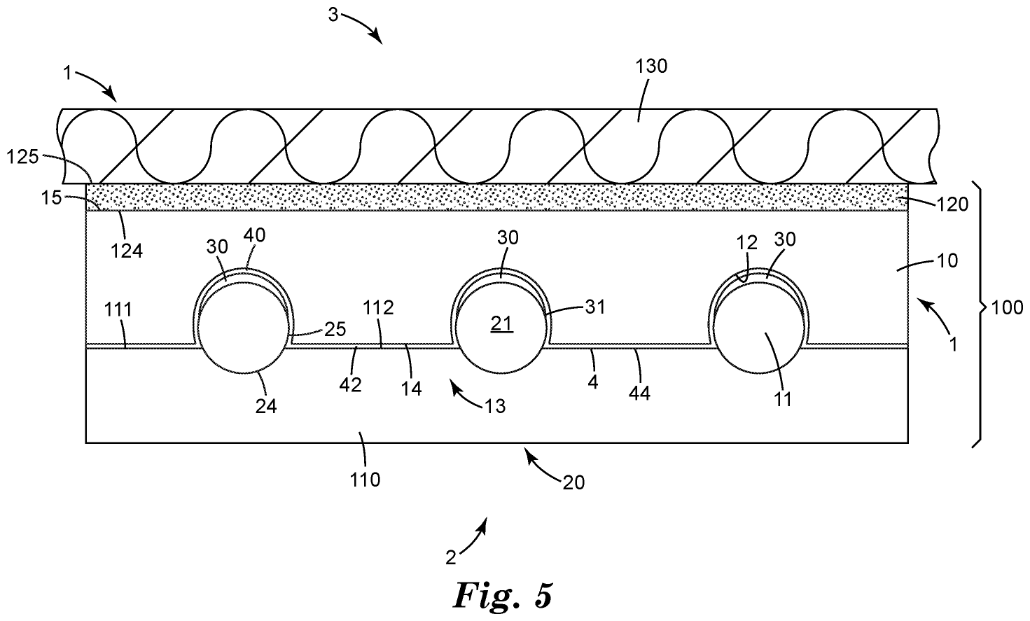

In some embodiments, a retroreflective article 1 as disclosed herein may be provided as part of a transfer article 100 that includes retroreflective article 1 along with a removable carrier layer 110. (In some convenient embodiments, retroreflective article 1 may be built on such a carrier layer 110, which may be removed for eventual use of article 1 as described below.) For example, a front side 2 of article 1 may be in releasable contact with a rear surface 111 of a carrier layer 110, as shown in exemplary embodiment in FIG. 5. Retroreflective article 1 (e.g. while still a part of a transfer article 100) may be coupled to any desired substrate 130, as shown in FIG. 5. In some embodiments this may be done by the use of a bonding layer 120 that is used to couple article 1 to a substrate 130, with the rear side 3 of article 1 facing the substrate 130. In some embodiments, such a bonding layer 120 can bond binder layer 10 (or any layer rearwardly disposed thereon) of article 1 to substrate 130. Such a bonding layer 120 may be e.g. a pressure-sensitive adhesive (of any suitable type and composition) or a heat-activated adhesive (e.g. an “iron-on” bonding layer). Various pressure-sensitive adhesives are described in detail in U.S. Patent Application Publication No. 2017/0276844, which is incorporated by reference in its entirety herein.

The term “substrate” is used broadly and encompasses any item, portion of an item, or collection of items, to which it desired to e.g. couple or mount a retroreflective article 1. Furthermore, the concept of a retroreflective article that is coupled to or mounted on a substrate is not limited to a configuration in which the retroreflective article is e.g. attached to a major surface of the substrate. Rather, in some embodiments a retroreflective article may be e.g. a strip, filament, or any suitable high-aspect ratio article that is e.g. threaded, woven, sewn or otherwise inserted into and/or or through a substrate so that at least some portions of the retroreflective article are visible. In fact, such a retroreflective article (e.g. in the form of a yarn) may be assembled (e.g. woven) with other, e.g. non-retroreflective articles (e.g. non-retroreflective yarns) to form a substrate in which at least some portions of the retroreflective article are visible. The concept of a retroreflective article that is coupled to a substrate thus encompasses cases in which the article effectively becomes a part of the substrate.

In some embodiments, substrate 130 may be a portion of garment. The term “garment” is used broadly, and generally encompasses any item or portion thereof that is intended to be worn, carried, or otherwise present on or near the body of a user. In such embodiments article 1 may be coupled directly to a garment e.g. by a bonding layer 120 (or by sewing, or any other suitable method). In other embodiments substrate 130 may itself be a support layer to which article 1 is coupled e.g. by bonding or sewing and that adds mechanical integrity and stability to the article. The entire assembly, including the support layer, can then be coupled to any suitable item (e.g. a garment) as desired. Often, if may be convenient for carrier 110 to remain in place during the coupling of article 1 to a desired entity and to then be removed after the coupling is complete. Strictly speaking, while carrier 110 remains in place on the front side of article 1, the areas 24 of transparent microspheres 21 will not yet be air-exposed and thus the retroreflective elements 20 may not yet exhibit the desired level of retroreflectivity. However, an article 1 that is detachably disposed on a carrier 110 that is to be removed for actual use of article 1 as a retroreflector, will still be considered to be an exposed-lens retroreflective article as characterized herein.

In some embodiments, a retroreflective article 1 can be made by starting with a carrier layer 110. Transparent microspheres 21 can be partially (and releasably) embedded into carrier layer 110 to form a substantially mono-layer of microspheres. For such purposes, in some embodiments carrier layer 110 may conveniently comprise e.g. a heat-softenable polymeric material that can be heated and the microspheres deposited thereonto in such manner that they partially embed therein. The carrier layer can then be cooled so as to releasably retain the microspheres in that condition for further processing. Typically, the microspheres as deposited are at least slightly laterally spaced apart from each other although occasional microspheres may be in lateral contact with each other.

In various embodiments the microspheres 21 may be partially embedded in carrier 110 e.g. to about 20 to 50 percent of the microspheres' diameter. The areas 25 of microspheres 21 that are not embedded in the carrier protrude outward from the carrier so that they can subsequently receive localized, embedded color layer 30, reflective layer 40, and binder layer 10 (and any other layers as desired). These areas 25 (which will form the embedded areas 25 of the microspheres in the final article) will be referred to herein as protruding areas of the microspheres during the time that the microspheres are disposed on the carrier layer. As noted earlier, there may be some variation in how deeply the different microspheres are embedded into carrier 110, which may affect the size and/or shape of the localized color layers that are deposited onto the protruding surfaces of the different microspheres.

Transparent microspheres may be used of any suitable type. The term “transparent” is generally used to refer to a body (e.g. a glass microsphere) or substrate that transmits at least 50% of electromagnetic radiation at a selected wavelength or within a selected range of wavelengths. In some embodiments, the transparent microspheres may transmit at least 75% of light in the visible light spectrum (e.g., from about 400 nm to about 700 nm); in some embodiments, at least about 80%; in some embodiments, at least about 85%; in some embodiments, at least about 90%; and in some embodiments, at least about 95%. In some embodiments, the transparent microspheres may transmit at least 50% of radiation at a selected wavelength (or range) in the near infrared spectrum (e.g. from 700 nm to about 1400 nm). In various embodiments, transparent microspheres may be made of e.g. inorganic glass, may have an average diameter of e.g. from 30 to 200 microns, and/or may have a refractive index of e.g. from 1.7 to 2.0. The vast majority (e.g. at least 90% by number) of the microspheres may be at least generally, substantially, or essentially spherical in shape. However, it will be understood that microspheres as produced in any real-life, large-scale process may comprise a small number of microspheres that exhibit slight deviations or irregularities in shape. Thus, the use of the term “microsphere” does not require that these items must be e.g. perfectly or exactly spherical in shape.

Further details of suitable carrier layers, methods of temporarily embedding transparent microspheres in carrier layer, and methods of using such layers to produce a retroreflective article, are disclosed in U.S. Patent Application Publication No. 2017/0276844.

After microspheres 21 are partially embedded in carrier 110, color layers that will become localized, embedded color layers 30 can be applied to the protruding areas 25 of any selected microspheres. In various embodiments, a single color layer 30 can be applied to all of the microspheres; or, it can be applied only to microspheres that are in selected areas. In some embodiments, a first color layer 30 may be applied in one or more areas 5 (of the resulting article 1) and second, differing color layer 50 may be applied to one or more other areas 6. A color layer may be applied by any method that can deposit a color layer (strictly speaking, that can deposit a color layer precursor that can solidify e.g. by drying, curing, or the like to form the actual color layer) in such manner that the color layer is localized (e.g. embedded) as defined and described earlier herein.

In many convenient embodiments a deposition process may be arranged to provide that a color layer is deposited only on protruding areas 25 of microspheres 21 and not, for example, on the surface 111 of the carrier 110. For example, a physical transfer process may be used in which a color layer precursor is brought in close proximity to the protruding areas of the microspheres so that the color layer precursor transfers to at least portions of the protruding areas of the microspheres without transferring to the surface of the carrier to any significant extent. Any such transfer process will be characterized herein as a “printing” process, and will be contrasted with a “coating” process in which a color layer precursor is deposited not only on the protruding areas of the microspheres but also on the surface of the carrier, between the microspheres.

In some such embodiments, a contact printing method may be used in which a color layer precursor is disposed on a printing surface that is brought in close proximity to microsphere-bearing carrier 110 so that the color layer precursor transfers to at least portions of the protruding areas 25 of microspheres 21 without transferring to the surface 111 of carrier 110. In some convenient embodiments, this may be performed by flexographic printing with the microsphere-bearing carrier 110 being the printing substrate and with the color layer precursor being the material to be printed. The closeness with which the printing surface (e.g. the surface of a flexographic printing plate) approaches the protruding microsphere areas 25, the pressure with which the printing plate and carrier 110 are brought close to each other, the viscosity of the color layer precursor, the rigidity/conformability of the flexographic printing plate, and so on, may be controlled to provide that the color layer precursor is transferred only to the protruding areas 25 of microspheres 21. (That is, such parameters may be controlled to ensure that the color layer precursor is not transferred to any significant extent to the carrier surface 111.) In fact, such parameters may be controlled to provide that the color layer precursor is transferred to a larger or smaller percentage of protruding areas 25 of microspheres 21, as desired. Methods of achieving such control will be readily apparent to those of ordinary skill in the art of flexographic printing, based on the disclosures herein.

In particular embodiments the transfer (e.g. printing) process may be controlled so that the color layer precursor is not disposed on the entirety of the protruding area 25 of a microsphere 21. That is, in some instances the transfer process may be carried out so that the color layer precursor is transferred only to an outermost portion of the protruding area 25 of microsphere 21 (that will become the rearmost portion of embedded area 25 of microsphere 21 in the final article).

By way of a specific example, in some embodiments a microsphere 21 may be disposed on a carrier 110 so that about 50% of the microsphere diameter is embedded in the carrier. Thus, about 50% of the diameter of the microsphere will protrude outward from surface 111 of the carrier. The transfer process may be performed so that the color layer precursor is only deposited e.g. on an outermost portion of the microsphere. Furthermore, the precursor composition and the process conditions may be chosen so that the precursor does not spread, run or wick along the protruding surface of the microsphere to any significant extent. After the deposition process is complete, there will be a remaining portion 27 of the protruding microsphere area 25 that will not comprise a color layer 30 thereon. Upon transferring microsphere 21 to a binder layer 10 (and removing carrier 110 therefrom), a retroreflective element 20 may be formed comprising a microsphere 21 and color layer 30 arranged in the general manner depicted in FIG. 2. That is, microsphere 21 will be embedded in the binder layer to a depth of about 50% of the microsphere diameter, with color layer 30 occupying only a rearward portion of embedded area 25 of microsphere 21. Specifically, color layer 30 does not occupy forward portion 27 of embedded area 25. Such an approach can provide a localized, embedded color layer 30 (e.g. which occupies an angular arc of in the range of approximately 90 degrees in the exemplary depiction of FIG. 2). However, as noted previously, an actual color layer, e.g. as achieved by a transfer process such as flexographic printing, may not necessarily be as symmetrical as the exemplary depiction shown in FIG. 2.

Other methods of contact transfer/printing may be used as an alternative to flexographic printing. Such methods may include e.g. micro-contact printing, pad printing, soft lithography, gravure printing, offset printing, and the like. In general, any deposition method (e.g. inkjet printing) may be used, as long as the process conditions and the flow properties of the color layer precursor are controlled so that the resulting color layer is a localized, embedded color layer. It will be appreciated that whatever the method used, it may be advantageous to control the method so that the color layer precursor is deposited in a very thin layer (e.g. a few microns or less) and at an appropriate viscosity, to provide that the precursor remains at least substantially in the area in which it was deposited. Such arrangements may ensure that, for example, the resulting color layer occupies a desired angular arc in the manner described above. It will also be appreciated that some deposition methods may provide a color layer 30 in which the thickness may vary somewhat from place to place. In other words, the rearward major surface 33 of the color layer may not necessarily be exactly congruent with the forward major surface 32 of the color layer. However, at least some amount of variation of this type (as may occur e.g. with flexographic printing) has been found to be acceptable in the present work.

As mentioned briefly earlier herein, in some embodiments a layer (e.g. a transparent layer) of organic polymeric material may be positioned rearward of the microspheres in the retroreflective article. In various embodiments, such a layer, if present, may be deposited before or after the color layer(s) and thus may be positioned forward or rearward of the color layer(s). Such a layer may serve any desired function, e.g. it may serve as a protective layer. In some embodiments such a layer may serve as a bonding layer e.g. for a transferred reflective layer as discussed below. Organic polymeric layers (e.g. protective layers) and potentially suitable compositions thereof are described in detail in U.S. Patent Application Publication No. 2017/0276844, which is incorporated by reference in its entirety herein. In particular embodiments, such a layer may be comprised of a polyurethane material. Various polyurethane materials that may be suitable for such purposes are described e.g. in U.S. Patent Application Publication No. 2017/0131444, which is incorporated by reference in its entirety herein.

With the localized, embedded color layer or layers 30 disposed on protruding areas 25 of transparent microspheres 21, a reflective layer or layers 40 may then be disposed thereon. This may be done e.g. by vapor deposition e.g. of a continuous metal layer such as aluminum or silver, by deposition of numerous high and low refractive index layers to form a dielectric reflective layer, by printing or otherwise disposing a material comprising a reflective additive (e.g. by printing a silver ink or a material comprising pearlescent pigment), by including a reflective additive in the binder layer, by transferring (e.g. laminating) a separately-made reflective layer and so on. Any suitable method may be chosen, and may be performed to provide a continuous reflective layer, or (e.g. by suitable masking or otherwise) a multiplicity of discontinuous reflective layers. As noted, in some embodiments a discontinuous reflective layer may be a localized reflective layer; in particular embodiments it may be an embedded reflective layer.

In various embodiments, any such discontinuous reflective layer may be provided e.g. by printing a reflective ink on portions of protruding areas of carrier-borne transparent microspheres. Or, such a reflective layer may be provided e.g. by coating a reflective layer (e.g. by vapor coating) onto a carrier and microspheres thereon, and then removing (e.g. by etching) the reflective layer selectively from the surface of the carrier while leaving localized reflective layers in place on the microspheres. In some particular embodiments of this type, a resist material may be applied (e.g. by a transfer process such as flexographic printing) on the portions of a reflective layer that are atop the protruding areas of the microspheres, but is not applied to portions of the reflective layer that are on the carrier surface between the microspheres. An etchant can then be applied that removes the reflective layer except the portions thereof that are protected by the resist material. Such methods are described in further detail in U.S. Provisional Patent Application No. 62/578,343, which is incorporated by reference herein. Alternatively, in some embodiments, measures may be taken to ensure that when a reflective layer is deposited (e.g. by vapor coating) onto transparent microspheres and onto a surface of a carrier that bears the microspheres, the portion of the reflective layer that is on the surface of the carrier is retained on the carrier rather than being transferred to a binder layer. Such arrangements (which are described in detail in U.S. Patent Application Publication No. 2016/0245966, which is incorporated by reference herein in its entirety) can provide that the resulting retroreflective article comprises localized reflective layers.

In some embodiments, transfer methods may be particularly useful for providing a discontinuous reflective layer 40, e.g. a localized, embedded reflective layer. Such terminology denotes a physical transfer approach in which a reflective layer is separately formed, as a continuous, macroscopic entity (e.g. as part of a multilayer substrate that includes a removable support layer that supports the reflective layer during handling). The pre-made reflective layer is brought into close proximity to a protruding area 25 of a transparent microsphere 21 disposed on a carrier 110, so that a local area of the reflective layer contacts a bonding layer that is present on at least a portion of the protruding area 25 of the microsphere and is physically transferred thereto. In such a process the local area of the reflective layer will detach from the laterally-surrounding area of the reflective layer, with the laterally-surrounding area of the reflective layer being removed along with remaining layers of the multilayer substrate. Such a physical transfer method may be considered to be a local lamination process, and can provide a discontinuous reflective layer, e.g. a localized reflective layer, e.g. in particular an embedded reflective layer. Methods of making such reflective layers (referred to as “transferred” layers) are described in detail in the aforementioned U.S. Provisional Patent Application No. 62/578,343 (e.g., in Example 2.3 (including Examples 2.3.1-2.3.3) and Example 2.4 (including Examples 2.4.1-2.4.5).

As noted earlier herein, in some embodiments a localized embedded reflective layer may be disposed so that it occupies an angular arc that is less than that of an embedded color layer with which it shares a retroreflective light path. Thus in some embodiments, the reflective layer may cover a lower percentage of the embedded area 25 of the transparent microsphere 21 than that covered by the color layer 30. In particular embodiments of this type, the entirety of the reflective layer will be positioned rearward of the color layer (in other words, in such embodiments no portion of the reflective layer will extend beyond the boundaries of the color layer to provide a retroreflective path that encounters the reflective layer but not the color layer).

The processes that are used to dispose the color layer and the reflective layer may be chosen and controlled to ensure that each layer is disposed in such manner as to achieve this. For example, a color layer deposition process and a discontinuous reflective layer transfer process may be performed to provide that the resulting reflective layer is not offset relative to the color layer. If it is desired for retroreflective article 1 to include one or more non-localized color layers 60 of the general type described earlier herein, these may be provided at any appropriate point during the production process, and may be provided e.g. by any suitable deposition process. In many convenient embodiments, a non-localized color layer precursor may be coated onto microsphere-bearing surface 111 of carrier 110, and solidified to form a non-localized color layer in areas of the carrier laterally between the microspheres. This color layer may then be transferred to areas 13 of binder layer 10 to form the non-localized color layer 60 of the final article, e.g. as shown in FIG. 4.

In some embodiments (particularly if reflective layer 40 is a continuous opaque reflective layer) the deposition of a non-localized color layer 60 may be performed before the formation of reflective layer 40, e.g. so that color layer 60 is not buried beneath reflective layer 40 in such a manner that it cannot be seen.

In some embodiments a non-localized color layer 60 may be coated onto selected areas of microsphere-bearing carrier 110, to (after being transferred to the binder layer) provide ambient color in corresponding areas (e.g. area 7 of FIG. 4) of the final article. In this context, coated means that the non-localized color layer is disposed on the entirety of the selected area of the carrier, including the areas 112 of carrier surface 111 that are laterally between microspheres 21, as well as on the protruding areas 25 of microspheres 21 (or on a layer already present thereon). For microspheres 21 on which a localized color layer 30 is already present, the presence of a two-layer, two-color stack in the retroreflective light path may cause the actual color displayed in retroreflected light to be affected by both localized color layer 30 and non-localized color layer 60. In such embodiments these color layers may thus be chosen so that their combined effects provide a desired color in retroreflection.

However, in some embodiments, procedures may be followed that provide that in the final article 1, only a relatively small amount, if any, of non-localized color layer 60 will remain in a location between localized color layer 30 and reflective layer 40. (In such cases the color in retroreflected light will be dominated by localized color layer 30 which can be chosen as desired.) That is, even if portions of a non-localized color layer are initially deposited atop an existing localized color layer on carrier-borne microspheres 21, methods can be used to preferentially remove or relocate such portions e.g. before a reflective layer is subsequently provided. Such methods can provide a final article that comprises a non-localized color layer 60 in at least some areas 8 of article 1 that are laterally between microspheres 21, while minimizing any amount of such a color layer 60 that remains in place between the localized color layer 30 and the reflective layer 40. Methods of achieving such arrangements are presented in U.S. Patent Application Publication No. 2011/0292508, which is incorporated by reference herein.

After any version or combination of the above-described processes is carried out, a binder precursor (e.g., a mixture or solution of binder layer components) can be applied onto microsphere-bearing carrier 110. The binder precursor may be disposed, e.g. by coating, onto the microsphere-loaded carrier and then hardened to form a binder layer, e.g. a continuous binder layer. The binder may of any suitable composition, e.g. it may be formed from a binder precursor that comprises an elastomeric polyurethane composition along with any desired additives, etc. Binder compositions, methods making binders from precursors, etc., are described in U.S. Patent Application Publication Nos. 2017/0131444 and 2017/0276844. which are incorporated by reference in their entirety herein. As noted, in some embodiments a binder may comprise one or more colorants. In particular embodiments a binder may comprise one or more fluorescent pigments. Suitable pigments may be chosen e.g. from those listed in the above-cited '444 and '844 Publications.

If desired, a substrate 130 (e.g., a fabric) can optionally be embedded in the binder precursor before the precursor is hardened to form the binder layer 10. (This can provide a substrate 130 that is directly bonded to the binder layer without requiring e.g. an adhesive layer, sewing, etc.). Alternatively, in some embodiments a bonding layer (e.g. an adhesive layer) 120 may be disposed on the rear side of binder layer 10, e.g. with a front surface 124 of the bonding layer in contact with a rear surface 15 of the binder layer. (Strictly speaking, even if a fabric layer is provided, an adhesive layer, e.g. an iron-on adhesive, may still be provided to facilitate coupling of the fabric layer/article 1 e.g. to a garment.)

The thus-formed construction, with carrier 110 still in place, is termed a transfer article (identified by reference number 100 in FIG. 5). The transfer article can then be coupled to a substrate (e.g. a rear surface 125 of a bonding layer 120 can be bonded to a front surface of a substrate) if no substrate was embedded in the binder layer in the manner described above. The substrate may be a fabric of a garment; or, it may be a sheet material (e.g. a patch) that will be further coupled to a garment in any desired manner. Typically, the carrier 110 will be removed (e.g. peeled off) at a desired time. In some embodiments the carrier may be removed after the transfer article has been coupled to a desired substrate, e.g. as a final step in the formation of the retroreflective article, in place on a desired garment.

As noted earlier herein, in some embodiments a color layer may perform wavelength-selective absorption of electromagnetic radiation at at least somewhere in a range that includes visible light, infrared radiation, and ultraviolet radiation, by the use of a colorant that is disposed in the color layer. The term colorant broadly encompasses pigments and dyes. Conventionally, a pigment is considered to be a colorant that is generally insoluble in the material in which the colorant is present and a dye is considered to be a colorant that is generally soluble in the material in which the colorant is present. However, there may not always be a bright-line distinction as to whether a colorant behaves as a pigment or a dye when dispersed into a particular material. The term colorant thus embraces any such material regardless of whether, in a particular environment, it is considered to be a dye or a pigment.

In some embodiments, suitable dyes include for instance and without limitation, Chlorophenol Red, Acid Orange 12, Acid Blue 25, Eriochrome Black T, Lissamine Green B, Acid Fuchsin, Alizarin Blue Black B, Acid Blue 80, Acid Blue 9, Brilliant Blue G, Water Soluble Nigrosin, Methylene Blue, Crystal Violet, Safranin, Basic Fuchsin, and combinations thereof. A single dye or a mixture of two or more dyes can be used to achieve a desired color. Suitable pigments may be chosen from, for example, products available from Cabot Corporation (Boston, Mass.) under the trade designation CAB-O-JET, and products available from Penn Color (Doylestown, Pa.) under various trade designations (e.g. 9R1252 and 9S1250). In some embodiments, a colorant may comprise a suitable near infrared wavelength absorbing materials chosen from e.g. infrared (IR) absorbing dyes, IR absorbing pigments such as nanoparticles of lanthanum hexaboride (LaB₆) and doped metal oxides including antimony-doped tin oxide (ATO), indium-doped tin oxide (ITO), mixed valent tungsten oxides such as cesium tungsten oxide (CWO), and so on. Any suitable combination of any such dye or dyes, and any such pigment or pigments, may be used as desired. Dyes and pigments, and sizes thereof, that may be suitable for the uses herein are described in U.S. Provisional Patent Application No. 62/650,381, which is incorporated in its entirety herein. It will be appreciated that including a colorant in a material (e.g. a localized or non-localized color layer, a binder layer, etc.) for the purposes disclosed herein will be distinguished from, for example, including low levels of components (e.g. UV absorbers) in order to achieve environmental stability and for similar purposes.

Any suitable colorant(s) may be included in a printable composition in order for the colorant to be disposed in a color layer of a retroreflective element. For example, a colorant may be mixed into a commercially available flexographic printing composition; or, it may be mixed into a custom-made printable composition. In some embodiments, a flexographic printing composition (e.g. a printing ink) may be commercially available with a suitable ink or pigment already present therein; such compositions may be used as-is. Any such printable composition, whether e.g. an off-the-shelf composition or a custom-made composition, may rely on any suitable ingredients and/or solidification mechanism. For example, in some embodiments a printable composition may be a water-borne composition (e.g. a polyurethane dispersion, an acrylic dispersion, and so on); or, it may be a solvent-based composition. The composition may solidify e.g. by the removal of a volatile component such as water or an organic solvent. In some embodiments the composition may solidify by chemical crosslinking (e.g. of (meth)acrylate groups or other reactive groups), whether promoted thermally and/or by e.g. UV radiation, electron beam, or the like. For example, the composition may a 100% active (e.g. solventless) (meth)acrylate composition that is e.g. photocurable. Any such approach, and combinations thereof, may be used.

To impart wavelength selectivity to a retroreflective element, in various embodiments a color layer may absorb radiation at least one wavelength between 350 nm and 10,600 nm, for instance at least one wavelength of 350 nm or greater, 400 nm or greater, 450 nm or greater, 500 nm or greater, 550 nm or greater, 600 nm or greater, 650 nm or greater, or 700 nm or greater; and at least one wavelength of 10,600 nm or less, 10,000 nm or less, 9,000 nm or less, 8,000 nm or less, 7,000 nm or less, 6,000 nm or less, 5,000 nm or less, 4,000 nm or less, 3,000 nm or less, 2,000 nm or less, 1,700 nm or less, 1,400 nm or less, 1,000 nm or less, 900 nm or less, 850 nm or less, 800 nm or less, or 750 nm or less. Stated another way, a color layer may absorb at least one wavelength between 350 nm and 10,600 nm, between 350 nm and 1400 nm, between 350 nm and 750 nm (e.g., a typical visible light wavelength range), or between 750 nm and 1400 nm (e.g., a typical near infrared light wavelength range).

As noted earlier, an article as disclosed herein may exhibit colors (whether imparted e.g. by a localized color layer, a non-localized color layer, or a colored binder layer) whose similarity or differences may be characterized using a CIE 1931 XYZ color space chromaticity diagram. That is, differences or similarities between colors may be characterized according to (x, y) chromaticity coordinates, and/or according to color luminance (Y), e.g. as discussed in U.S. Patent Application Publication Nos. 2017/0276844 and 2017/0293056. These Publications, which are incorporated by reference in their entirety herein, also discuss methods of characterizing retroreflectivity according to e.g. a coefficient of retroreflectivity (R_{A}). In various embodiments, at least selected areas of article 1 may exhibit a coefficient of retroreflectivity, measured in accordance with the procedures outlined in these Publications, of at least 50, 100, 200, 250, 350, or 450 candela per lux per square meter.

In various embodiments, retroreflective articles as disclosed herein may meet the requirements of ANSI/ISEA 107-2015 and/or ISO 20471:2013. In many embodiments, retroreflective articles as disclosed herein may exhibit satisfactory, or excellent, wash durability. Such wash durability may be manifested as high R_{A} retention (a ratio between R_{A} after wash and R_{A} before wash) after numerous (e.g. 25) wash cycles conducted according to the method of ISO 6330 2A, as outlined in U.S. Patent Application Publication No. 2017/0276844. In various embodiments, a retroreflective article as disclosed herein may exhibit a percent of R_{A} retention of at least 30%, 50%, or 75% after 25 such wash cycles.

In some embodiments, a retroreflective article as disclosed herein may be configured for use in or with a system that performs e.g. machine vision, remote sensing, surveillance, or the like. Such a machine vision system may rely on, for example, one or more visible and/or near-infrared (IR) image acquisition systems (e.g. cameras) and/or radiation or illumination sources, along with any other hardware and software needed to operate the system. In some such embodiments, at least some retroreflective elements of the article may comprise at least two different retroreflective properties (e.g. intensity, brightness, color, contrast, and so on). In particular embodiments, such properties may be e.g. wavelength-dependent and/or angle-dependent. Thus in some embodiments, a retroreflective article as disclosed herein (whether or not it is mounted on a substrate) may be a component of, or work in concert with, a machine vision system of any desired type and configuration. Such a retroreflective article may, for example, be configured to be optically interrogated (whether visually or by near-IR, e.g. at a distance of up to several meters) regardless of the ambient light conditions. Thus in various embodiments, such a retroreflective article may comprise retroreflective elements configured to collectively exhibit any suitable image(s), code(s), pattern, or the like, that allow information borne by the article to be retrieved by a machine vision system. Exemplary machine vision systems, ways in which retroreflective articles can be configured for use in such systems, and ways in which retroreflective articles can be characterized with specific regard to their suitability for such systems, are disclosed in U.S. Provisional Patent Application No. 62/536,654, which is incorporated by reference in its entirety herein.

Various components of retroreflective articles (e.g. transparent microspheres, binder layers, reflective layers, etc.), methods of making such components and of incorporating such components into retroreflective articles in various arrangements, are described e.g. in U.S. Patent Application Publication Nos. 2017/0131444, 2017/0276844, and 2017/0293056, and in U.S. Provisional Patent Application No. 62/578,343, all of which are incorporated by reference in their entirety herein.

It will be appreciated that retroreflective elements comprising localized color layers as disclosed herein, can be used in any retroreflective article of any suitable design and for any suitable application. In particular, it is noted that the requirement of the presence of retroreflective elements comprising transparent microspheres (along with one or more localized color layers, reflective layers, etc.) does not preclude the presence, somewhere in the article, of other retroreflective elements (e.g. so-called cube-corner retroreflectors) that do not comprise transparent microspheres.

Although discussions herein have mainly concerned use of the herein-described retroreflective articles with garments and like items, it will be appreciated that these retroreflective articles can find use in any application, as mounted to, or present on or near, any suitable item or entity. Thus, for example, retroreflective articles as disclosed herein may find use in pavement marking tapes, road signage, vehicle marking or identification (e.g. license plates), or, in general, in reflective sheeting of any sort. In various embodiments, such articles and sheeting comprising such articles may present information (e.g. indicia), may provide an aesthetic appearance, or may serve a combination of both such purposes.

### LIST OF EXEMPLARY EMBODIMENTS

Embodiment 1 is an exposed-lens retroreflective article comprising: a binder layer; and, a plurality of retroreflective elements spaced over a length and breadth of a front side of the binder layer, each retroreflective element comprising a transparent microsphere partially embedded in the binder layer; wherein at least some of the retroreflective elements comprise a reflective layer disposed between the transparent microsphere and the binder layer and at least one localized color layer that is embedded between the transparent microsphere and the reflective layer.

Embodiment 2 is the exposed-lens retroreflective article of embodiment 1 wherein at least some of the localized, embedded color layers occupy an angular arc of, on average, from 45 degrees to 100 degrees.

Embodiment 3 is the exposed-lens retroreflective article of any of embodiments 1-2 wherein the article comprises at least one first area comprising first localized embedded color layers that exhibit a first color, and at least one second area comprising second localized embedded color layers that exhibit a second color that is different from the first color.

Embodiment 4 is the exposed-lens retroreflective article of any of embodiments 1-3 wherein at least a portion of a visually exposed front surface of the article in areas laterally between the transparent microspheres, is provided by a visually exposed surface of a color layer that is a non-localized color layer.

Embodiment 5 is the exposed-lens retroreflective article of any of embodiments 1-4 wherein the binder layer comprises a colorant.

Embodiment 6 is the exposed-lens retroreflective article of any of embodiments 1-5 wherein at least some of the retroreflective elements each comprise a reflective layer that is a portion of a non-localized reflective layer.

Embodiment 7 is the exposed-lens retroreflective article of any of embodiments 1-6 wherein at least some of the retroreflective elements each comprise a reflective layer that is a localized reflective layer.

Embodiment 8 is the exposed-lens retroreflective article of any of embodiments 1-6 wherein at least some of the retroreflective elements each comprise a localized reflective layer that is an embedded reflective layer that is embedded between the transparent microsphere and the binder layer.

Embodiment 9 is the exposed-lens retroreflective article of embodiment 8 wherein at least some of the embedded reflective layers are embedded between the localized embedded color layer and the binder layer.

Embodiment 10 is the exposed-lens retroreflective article of any of embodiments 7-9 wherein at least some of the retroreflective elements each comprise a localized reflective layer that occupies an angular arc that is less than an angular arc occupied by the localized embedded color layer of that retroreflective element, and in which the entirety of the localized reflective layer is located rearwardly of the localized embedded color layer.

Embodiment 11 is the exposed-lens retroreflective article of any of embodiments 1-10 wherein at least some of the retroreflective elements each comprise a reflective layer that comprises a vapor-coated metal layer.

Embodiment 12 is the exposed-lens retroreflective article of any of embodiments 1-11 wherein at least some of the retroreflective elements each comprise a reflective layer that is a dielectric reflector layer comprising alternating high and low refractive index sublayers.

Embodiment 13 is the exposed-lens retroreflective article of any of embodiments 1-12 wherein the article exhibits a coefficient of retroreflectivity (R_{A}, measured at 0.2 degrees observation angle and 5 degrees entrance angle) after 25 wash cycles, that is at least 50% of a coefficient of retroreflectivity initially exhibited before any wash cycles.

Embodiment 14 is a transfer article comprising the exposed-lens retroreflective article of any of embodiments 1-13 and a carrier layer on which the exposed-lens retroreflective article is detachably disposed with at least some of the transparent microspheres in contact with the carrier layer.

Embodiment 15 is a substrate comprising the exposed lens retroreflective article of any of embodiments 1-14, wherein the binder layer of the retroreflective article is coupled to the substrate with at least some of the retroreflective elements facing away from the substrate.

Embodiment 16 is the substrate of embodiment 15 wherein the substrate is a fabric of a garment.

Embodiment 17 is the substrate of embodiment 15 wherein the substrate is a support layer that supports the exposed-lens retroreflective article and that is configured to be coupled to a fabric of a garment.

Embodiment 18 is a method of making a retroreflective article comprising a plurality of retroreflective elements at least some of which each comprise a localized color layer, the method comprising: physically transferring at least one color layer precursor onto at least portions of protruding areas of transparent microspheres that are borne by a carrier layer and that are partially embedded therein; solidifying the color layer precursor into localized color layers, disposing a reflective layer on at least some of the localized color layers, disposing a binder precursor on the carrier layer and on the protruding areas of the transparent microspheres bearing the localized color layers and the reflective layers thereon, and, solidifying the binder precursor to form a binder layer. Embodiment 19 is the method of embodiment 18 wherein the physically transferring of the at least one color layer precursor comprises flexographic printing of the at least one color layer precursor.

Embodiment 20 is the method of any of embodiments 18-19 wherein for at least some of the transparent microspheres, the method comprises physically transferring the at least one color layer precursor onto a portion of the protruding area of the microsphere while leaving another portion of the protruding area of the microsphere without a color layer precursor thereon.

Embodiment 21 is the method of any of embodiments 18-19 wherein the method comprises a step of disposing a non-localized color layer precursor on a major surface of at least a selected area of a side of the carrier layer that bears the transparent microspheres.

Embodiment 22 is the article or substrate of any of embodiments 1-17 made by the method of any of embodiments 18-21.

### EXAMPLES

All parts, percentages, ratios, etc. in the examples and the rest of the specification are by weight, unless noted otherwise. Solvents and other reagents used are obtainable from Sigma-Aldrich Chemical Company; Milwaukee, Wis. unless otherwise noted.

TABLE 1
Materials

| Name | Description | Supplier |
|---|---|---|
| HDDA | 1,6-Hexanediol diacrylate | Sigma-Aldrich (Milwaukee, WI) |
| Irgacure 819 | Photo initiator | BASF (Florham Park, NJ) |
| 9R1252 | UV-curable magenta pigment | Penn Color (Doylestown, PA) |
| 9S1250 | UV-curable cyan pigment | Penn Color (Doylestown, PA) |
| Cab-O-Jet 250C | Water-based cyan pigment | Cabot (Boston, MA) |
| Cab-O-Jet 260M | Water-based magenta pigment | Cabot (Boston, MA) |
| Impranil DLC-F | Water-based polyurethane dispersion | Covestro (Pittsburgh, PA) |
| Impranil DLC-F/1 | Water-based polyurethane dispersion | Covestro (Pittsburgh, PA) |
| Vitel 3580 | Copolyester solution | Bostik (Wauwatosa, WI) |
| SILQUEST A | Gamma-isocyanatopropyltriethoxysilane | Momentive |
| 1310 | | Performance Materials, |
| | | (Strongsville, OH) |
| Desmodur L-75 | Aromatic polyisocyanate based on toluene | Covestro (Pittsburgh, PA) |
| | diisocyanate | |
| DBTDL | Dibutyltin dilaurate | Sigma-Aldrich (Milwaukee, WI) |

### Test Methods

Retroreflective light at an observation angle of 0.2 degrees and at an entrance angle of either 5 degrees or 30 degrees was measured using a RoadVista Field Retroreflectometer Model 932 (Gamma Scientific, UDT Instruments, San Diego, Calif.). Coefficient of retroreflecvity (R_{A} with unit of cd/lux/m²) and color coordinates (x and y in a CIE 1931 XYZ color space chromaticity diagram) were reported as the average over measurements of three different sample areas. Wash durability was reported as a percent of R_{A} retention (calculated as a ratio between R_{A} after wash and R_{A} before wash, each measured at an observation angle of 0.2 degrees and an entrance angle of 5 degrees) after indicated (e.g. 25) wash cycles conducted according to the method of ISO 6330 2A.

### Working Example 1

To make Working Example 1 Sample 1, an 8″-wide carrier layer was obtained, comprising a paper sheet coated with a layer of polyethylene, and bearing transparent glass microspheres of diameter in the range of 40-90 microns partially embedded into the polyethylene layer. The microsphere-bearing side of the carrier layer was flexographically printed with a UV-curable magenta ink formulation (see Table 2 for composition) using a conventional flexographic printing apparatus. The process conditions were as follows: 6″-wide closed-loop applicator, 2.5 BCM/in² (Billion Cubic Microns per square inch) and 900 lines/in anilox roll, line speed 10 feet per minute, UV curing under Nitrogen atmosphere. The flexographic printing plate was a rubber sleeve with Shore A hardness of 38 (Luminite Products Coop., Bradford, Pa.), fitted onto a standard flexographic printing roll. The printing roll was mated with a standard flexographic impression (backing) roll to provide a gap therebetween. The gap was adjusted as needed to obtain optimal transfer of the magenta ink formulation onto the protruding portions of the microspheres.

After the thus-printed magenta ink formulation was UV-cured, the printed side of the article was coated with a layer of aluminum (using conventional metal vapor-coating methods) to form a continuous reflective layer. The aluminum-coated article was then coated with a binder precursor (see Table 3 for composition) using a notch bar coater set at an 8 mil gap. The article was then held in an 88° C. oven for 30 seconds to partially harden the layer of binder precursor. A porous white polyester fabric was then laminated to the binder precursor so that the fabric partially penetrated into the binder precursor, after which the article was held in a 102° C. oven for 6 minutes. The article was then held for at least twelve hours at room temperature, after which the paper liner containing the polyethylene layer was removed to produce Working Example 1 Sample 1 (WE1-S1).

TABLE 2
Composition of UV-curable magenta ink

| Ingredient | Percent by weight |
|---|---|
| HDDA | 27.3 |
| Irgacure 819 | 1.0 |
| 9R1252 | 71.7 |

TABLE 3
Composition of binder precursor

| Ingredient | Percent by weight |
|---|---|
| Vitel 3580 | 93.4 |
| SILQUEST A 1310 | 1.8 |
| Desmodur L-75 | 4.6 |
| DBTDL | 0.2 |

To make Working Example 1 Sample 2, the above-described components and procedures were used with the following differences: the ink was a UV-curable cyan ink formulation (see Table 4 for composition), a 0.6 BCM/in² (2000 lines/in) anilox roll was used, and the line speed was 100 feet per minute. The thus-produced article was Working Example 1 Sample 2 (WE1-S2).

TABLE 4
Composition of the UV-curable cyan ink.

| Ingredient | Percent by weight |
|---|---|
| HDDA | 29.0 |
| Irgacure 819 | 1.0 |
| 9S1250 | 70.0 |

Each of the thus-produced articles comprised retroreflective elements that each included a color layer that was discontinuous, localized, and embedded, and that included a continuous reflective layer. (That is, these Samples comprised retroreflective elements that generally resembled the arrangement shown in generic representation in FIG. 5.)

### Comparative Examples

For comparative purposes, commercially available retroreflective articles were obtained. Each article was believed to include a colorizing overlayer atop transparent microspheres in the general manner described in U.S. Pat. No. 9,248,470. Comparative Sample 1 was Red and Comparative Example 2 was Blue. Comparative Sample 3 was 3M™ Scotchlite™ C750, which does not contain a colorizing overlayer.

### Evaluation

Working Examples Samples WE1-S1 and WE1-S2, and Comparative Samples 1, 2, and 3, were visually qualitatively evaluated by human volunteers, observing the samples in either ambient light or through a 3M hand retroviewer on both head-on and high angle (estimated to be approximately 45 degrees) retroreflected light. Results are reported in Table 5.

TABLE 5

| | Appearance in | Appearance in head-on | Appearance in high- |
|---|---|---|---|
| Sample | ambient light | retroreflected light | angle retroreflected light |
| Comparative | Red | Bright light, white with | Very dim light, red color |
| Sample 1 | | light blue color | |
| Comparative | Blue | Bright light, blue color | Very dim light, blue |
| Sample 2 | | | color |
| Comparative | Gray | Bright light, white with | Bright light, white with |
| Sample 3 | | light yellow color | light blue color |
| WE1-S1 | Gray with light | Bright light, red color | Bright light, white with |
| | magenta | | light blue color |
| WE1-S2 | Gray with light | Bright light, blue color | Bright light, white with |
| | blue | | light blue color |

Working Examples Samples 1 and 2, and Comparative Samples 1, 2 and 3, were also evaluated for R_{A}, x and y according to the apparatus and procedures noted above. Samples were evaluated at an observation angle of 0.2 degrees, at an entrance angle of 5 degrees and at an entrance angle of 30 degrees. Results are reported in Table 6 (In this and all other Tables, the nomenclature of a/b indicates observation angle/entrance angle).

TABLE 6

| | Angle | | | | | |
|---|---|---|---|---|---|---|
| | 0.2/5 | 0.2/30 | 0.2/5 | | 0.2/30 | |
| Sample | R_{A} | R_{A} | x | y | x | y |
| Comparative | 495 | 437 | 0.437 | 0.427 | 0.430 | 0.431 |
| Sample 3 | | | | | | |
| Comparative | 185 | 16 | 0.317 | 0.403 | 0.324 | 0.341 |
| Sample 1 | | | | | | |
| Comparative | 323 | 23 | 0.244 | 0.528 | 0.154 | 0.334 |
| Sample 2 | | | | | | |
| WE1-S1 | 199 | 140 | 0.628 | 0.357 | 0.604 | 0.371 |
| WE1-52 | 285 | 280 | 0.334 | 0.448 | 0.334 | 0.472 |

### Working Example 2

To make Working Example 2 Sample 3, the components and procedures of WE1-S1 were followed with the following differences: the ink was a water-based cyan ink formulation (see Table 7 for composition), the line speed was 25 feet per minute, and the ink-coated article was held in a 135° C. oven for 10 seconds to dry the ink (rather than the ink being UV-cured). The thus-produced article was Working Example 2 Sample 3 (WE2-S3).

TABLE 7
Composition of water-based cyan ink

| Ingredient | Percent by weight |
|---|---|
| Impranil DLC-F/1 | 50.0 |
| Cab-O-Jet 250C | 50.0 |

Working Example 2 Sample 4 was prepared following the same process as described for Sample WE2-S3 except that it used a water-based magenta ink formulation (see Table 8 for composition) instead of a water-based cyan ink formulation. The thus-produced article was Working Example 2 Sample 4 (WE2-S4).

TABLE 8
Composition of water-based magenta ink

| Ingredient | Percent by weight |
|---|---|
| Impranil DLC-F | 50.0 |
| Cab-O-Jet 260M | 50.0 |

Samples WE2-S3 and WE2-S4 were visually qualitatively evaluated by human volunteers in similar manner as for samples WE1-S1 and WE1-S2. Results are reported in Table 9.

TABLE 9

| | Appearance in | Appearance in head-on | Appearance in high-angle |
|---|---|---|---|
| Sample | ambient light | retroreflected light | retroreflected light |
| WE2-S3 | Gray with light | Bright light, blue color | Bright light, white with |
| | blue | | light blue color |
| WE2-S4 | Gray with light | Bright light, light pink | Bright light, white with |
| | magenta | color | light blue color |

Samples WE2-S3 and WE2-S4 were also evaluated for R_{A}, x and y according to the apparatus and procedure noted above. Results are reported in Table 10. Wash durability was evaluated according to the procedure noted above. Both Samples WE2-S3 and WE2-S4 retained 81% of R_{A} after 25 wash cycles conducted according to the method of ISO 6330 2A.

TABLE 10

| | Angle | | | | | |
|---|---|---|---|---|---|---|
| | 0.2/5 | 0.2/30 | 0.2/5 | | 0.2/30 | |
| Sample | R_{A} | R_{A} | x | y | x | y |
| WE2-S3 | 297 | 274 | 0.261 | 0.462 | 0.326 | 0.430 |
| WE2-S4 | 387 | 230 | 0.533 | 0.419 | 0.400 | 0.414 |

### Working Example 3

To make Working Example 3 Sample 5, the components and procedures of WE2-S4 were followed with the following differences: rather than using a (non-patterned) rubber sleeve as a printing plate, a printing plate was obtained (from Southern Graphics Systems, Brooklyn Park, Minn.) of the type available from DowDuPont under the trade designation Cyrel DPR 67. The plate material was reported DowDupont by the manufacturer as having a Shore A hardness of 69. The plate had been processed by conventional plate-preparation methods to comprise a macroscopic print pattern in the shape of a “3M” corporate logo. The thus-produced article was Working Example 3 Sample 5 (WE3-S5), and comprised some areas (in a macroscopic, “3M”-logo pattern) with retroreflective elements that each included a magenta color layer, and other areas (in the background) with retroreflective elements did not include a color layer.

To make Working Example 3 Sample 6, the components and procedures of WE2-S3 were followed with the following differences. A microsphere-bearing carrier layer was flexographically printed with a water-based cyan ink in the same manner as for WE2-S3, i.e. using an unpatterned rubber sleeve as the printing plate. The resulting article was then flexographically printed again, with a water-based magenta ink in the same manner as for WE3-S5, i.e. using a patterned (“3M” logo) printing plate. The thus-produced article (Sample WE3-S6) thus comprised some areas (in a macroscopic, “3M”-logo pattern) with retroreflective elements that each included a stack of a cyan color layer and a magenta color layer, and other areas (in the background) with retroreflective elements that included only a cyan color layer.

Samples WE3-S5 and WE3-S6 were visually qualitatively evaluated by human volunteers. Results are reported in Table 11.

TABLE 11

| | Appearance in | Appearance in head-on | Appearance in high- |
|---|---|---|---|
| Sample | ambient light | retroreflected light | angle retroreflected light |
| WE3-S5 | Gray with light | Bright light, pink color “3M” | Bright light, white with |
| | magenta “3M” on | pattern on white with light | light blue color |
| | gray background | blue color background | |
| WE3-S6 | Gray with light | Bright light, pink color “3M” | Bright light, white with |
| | magenta “3M” on | pattern on blue color | light blue color |
| | light blue | background | |
| | background | | |

### Working Example 4

To make Working Example 4 Sample 7, the components and procedures of WE1-S1 were followed with the following differences. A microsphere-bearing carrier layer was flexographically printed with a UV-curable magenta ink in the same manner as for WE1-S1. The resulting intermediate article was then coated with a cyan coating composition as found in Table 12. The coating was performed with a notch bar coater with 2 mil gap. The coated article was held in a 65° C. oven for 3 minutes followed by a 90° C. oven for 2 minutes. The resulting article was then processed (e.g., vapor-coated with aluminum, followed by coating of a binder precursor which was hardened to form a binder layer) in similar manner as for WE1-S1.

TABLE 12
Composition of cyan coating mixture

| Ingredient | Percent by weight |
|---|---|
| Cab-O-Jet 250C | 21.1 |
| water | 31.1 |
| ethanol | 31.1 |
| Impranil DLC-F | 16.8 |

Sample WE4-S7 thus comprised retroreflective elements that each included a localized (embedded) magenta color layer, and further comprised a non-localized cyan color layer in areas laterally between the transparent microspheres/retroreflective elements. It was believed that due e.g. to the properties (e.g. viscosity) of the cyan coating composition and the characteristics of the notch bar coating process, much of the cyan coating composition drained off of the protruding portions of the microspheres (onto the surface of the carrier layer, to then be transferred to the surface of the binder layer). Thus, only small amounts of cyan seemed to remain on the protruding portions of the microspheres.

To make Working Example 4 Sample 8, the components and procedures of WE1-S2 were followed with the following differences. A microsphere-bearing carrier layer was flexographically printed with a UV-curable cyan ink in the same manner as for WE1-S2. The resulting intermediate article was then coated with a magenta coating composition as found in Table 13. The coating was performed with a notch bar coater with 2 mil gap. The coated article was held in a 65° C. oven for 3 minutes followed by a 90° C. oven for 2 minutes. The resulting article was then processed in similar manner as for Sample WE4-S7, to produce Sample WE4-S8.

TABLE 13
Composition of magenta coating mixture

| Ingredient | Percent by weight |
|---|---|
| Cab-O-Jet 260M | 21.1 |
| Water | 31.1 |
| Ethanol | 31.1 |
| Impranil DLC-F | 16.8 |

Sample WE4-S8 thus comprised retroreflective elements that each included a localized (embedded) cyan color layer, and further comprised a non-localized magenta color layer in areas laterally between the transparent microspheres/retroreflective elements. It was believed that due e.g. to the properties (e.g. viscosity) of the magenta coating composition and the characteristics of the notch bar coating process, much of the magenta coating composition drained off of the protruding portions of the microspheres (onto the surface of the carrier layer, to then be transferred to the surface of the binder layer). Thus, only small amounts of magenta seemed to remain on the protruding portions of the microspheres.

Samples WE4-S7 and WE4-S8 were visually qualitatively evaluated by human volunteers. Results are reported in Table 14.

TABLE 14

| | Appearance in | Appearance in head-on | Appearance in high-angle |
|---|---|---|---|
| Sample | ambient light | retroreflected light | retroreflected light |
| WE4-S7 | Blue | Bright light, red color | Bright light, blue color |
| WE4-S8 | Purple | Bright light, blue color | Bright light, red color |

Samples WE4-S7 and WE4-S48 were also evaluated for R_{A}, x and y according to the apparatus and procedure noted above. Results are reported in Table 15.

TABLE 15

| | Angle | | | | | |
|---|---|---|---|---|---|---|
| | 0.2/5 | 0.2/30 | 0.2/5 | | 0.2/30 | |
| Sample | R_{A} | R_{A} | X | y | x | y |
| WE4-S7 | 189 | 178 | 0.585 | 0.385 | 0.417 | 0.383 |
| WE4-S8 | 252 | 260 | 0.304 | 0.388 | 0.428 | 0.383 |

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

What is claimed is:

1. An exposed-lens retroreflective article comprising:
a binder layer; and,
a plurality of retroreflective elements spaced over a length and breadth of a front side of the binder layer, each retroreflective element comprising a transparent microsphere partially embedded in the binder layer;
wherein at least some of the retroreflective elements comprise a reflective layer disposed between the transparent microsphere and the binder layer and at least one localized color layer that is embedded between the transparent microsphere and the reflective layer.

2. The exposed-lens retroreflective article of claim 1 wherein at least some of the localized, embedded color layers occupy an angular arc of, on average, from 45 degrees to 100 degrees.

3. The exposed-lens retroreflective article of claim 1 wherein the article comprises at least one first area comprising first localized embedded color layers that exhibit a first color, and at least one second area comprising second localized embedded color layers that exhibit a second color that is different from the first color.

4. The exposed-lens retroreflective article of claim 1 wherein at least a portion of a visually exposed front surface of the article in areas laterally between the transparent microspheres, is provided by a visually exposed surface of a color layer that is a non-localized color layer.

5. The exposed-lens retroreflective article of claim 1 wherein the binder layer comprises a colorant.

6. The exposed-lens retroreflective article of claim 1 wherein at least some of the retroreflective elements each comprise a reflective layer that is a portion of a non-localized reflective layer.

7. The exposed-lens retroreflective article of claim 1 wherein at least some of the retroreflective elements each comprise a reflective layer that is a localized reflective layer.

8. The exposed-lens retroreflective article of claim 1 wherein at least some of the retroreflective elements each comprise a localized reflective layer that is an embedded reflective layer that is embedded between the transparent microsphere and the binder layer.

9. The exposed-lens retroreflective article of claim 8 wherein at least some of the embedded reflective layers are embedded between the localized embedded color layer and the binder layer.

10. The exposed-lens retroreflective article of claim 7 wherein at least some of the retroreflective elements each comprise a localized reflective layer that occupies an angular arc that is less than an angular arc occupied by the localized embedded color layer of that retroreflective element, and in which the entirety of the localized reflective layer is located rearwardly of the localized embedded color layer.

11. The exposed-lens retroreflective article of claim 1 wherein at least some of the retroreflective elements each comprise a reflective layer that comprises a vapor-coated metal layer.

12. The exposed-lens retroreflective article of claim 1 wherein at least some of the retroreflective elements each comprise a reflective layer that is a dielectric reflector layer comprising alternating high and low refractive index sublayers.

13. The exposed-lens retroreflective article of claim 1 wherein the article exhibits a coefficient of retroreflectivity (R_{A}, measured at 0.2 degrees observation angle and 5 degrees entrance angle) after 25 wash cycles, that is at least 50% of a coefficient of retroreflectivity initially exhibited before any wash cycles.

14. A transfer article comprising the exposed-lens retroreflective article of claim 1 and a carrier layer on which the exposed-lens retroreflective article is detachably disposed with at least some of the transparent microspheres in contact with the carrier layer.

15. A substrate comprising the exposed lens retroreflective article of claim 1,
wherein the binder layer of the retroreflective article is coupled to the substrate with at least some of the retroreflective elements facing away from the substrate.

16. The substrate of claim 15 wherein the substrate is a fabric of a garment.

17. The substrate of claim 15 wherein the substrate is a support layer that supports the exposed-lens retroreflective article and that is configured to be coupled to a fabric of a garment.

18. A method of making a retroreflective article comprising a plurality of retroreflective elements at least some of which each comprise a localized color layer, the method comprising:
physically transferring at least one color layer precursor onto at least portions of protruding areas of transparent microspheres that are borne by a carrier layer and that are partially embedded therein;
solidifying the color layer precursor into localized color layers,
disposing a reflective layer on at least some of the localized color layers,
disposing a binder precursor on the carrier layer and on the protruding areas of the transparent microspheres bearing the localized color layers and the reflective layers thereon,
and,
solidifying the binder precursor to form a binder layer.

19. The method of claim 18 wherein the physically transferring of the at least one color layer precursor comprises flexographic printing of the at least one color layer precursor.

20. The method of claim 18 wherein for at least some of the transparent microspheres, the method comprises physically transferring the at least one color layer precursor onto a portion of the protruding area of the microsphere while leaving another portion of the protruding area of the microsphere without a color layer precursor thereon.

21. The method of claim 18 wherein the method comprises a step of disposing a non-localized color layer precursor on a major surface of at least a selected area of a side of the carrier layer that bears the transparent microspheres.
